(19) United States
(12) Patent Application Publication
(10) Pub. No.: US 2007/0238132 A1
(43) Pub. Date: Oct. 11, 2007

(54) Screening of combinatorial libraries using radioactivity

(75) Inventors: Xiao-Dong Xiang, Danville, CA (US); Jonathan Melman, San Mateo, CA (US); Gang Wang, San Jose, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/732,521

(22) Filed: Apr. 3, 2007

Related U.S. Application Data
(60) Provisional application No. 60/789,503, filed on Apr. 4, 2006.

(51) Int. Cl. C40B 30/06; C40B 40/04

(52) U.S. Cl. 435/7.1

(57) ABSTRACT

The combinatorial approach to materials synthesis can create vast libraries of materials. Some luminescent materials can be activated by the application of electrical current. Additionally, these materials can be activated by the application of an electron gun or some other electron source, such as a β-emitter. In its simplest form, a library of materials can be screened for luminescence by placing the library in a position to collect beta particles emitted from radioactive β-emitters.

### CROSS REFERENCE TO RELATED APPLICATIONS

This application claims the benefit of priority to U.S. Provisional Patent Application No. 60/789,503, filed Apr. 4, 2006, the provisional application is incorporated herein by reference.

### BACKGROUND OF THE INVENTION

1. Field of the Invention

Embodiments of the present invention are directed in general to the field of high throughput screening of combinatorial libraries. Specifically, the present embodiments are directed to the use of an electron flux from a radioactive substance, such as a beta emitter, to screen combinatorial libraries comprising luminescent materials.

2. Description of the Related Art

Radioactive materials have often been combined with luminescent materials such that the latter harvests the radioactive emissions from the former to emit light in a process commonly called radioluminescence. This technique has been used to illuminate watch dials, instrument dials, gun sights, light switches, exit signs, etc. The advantages of radioluminescence are that a recharging of the phosphor by exposure to an energy source such as ultraviolet or visible light is not needed, as is the case with other ‘glow-in-the-dark’ materials. What is more, an external energy source such as an electrical plug or battery is not necessary, as the energy is provided by the radioactive material.

A common application is the use of tritium (³H) in self-illuminating exit signs. Most current commercial uses of tritium utilize this radioactive material in the form of tritium gas, which is contained in a glass vial. The inside walls of the vial are coated with a phosphor material, usually a doped zinc sulfide. When a tritium atom decays a beta particle is released, the beta particle having a mean energy of about 6 keV. The beta particle bombards the phosphor resulting in emission of a plurality of photons. In a state of the art process, about 10 percent of the energy of the beta particles absorbed by the phosphor is converted into photon energy.

Prior art applications of tritium activated luminescence have included paint, wherein a paint containing phosphors and a solid containing chemically bound tritium were used together. Often in this type of application, the tritium was incorporated into a polymer.

### SUMMARY OF THE INVENTION

Embodiments of the present invention are directed to the use of an electron flux from a radioactive substance, such as a beta emitter, to screen combinatorial libraries comprising luminescent materials. Included are methods of screening a library of combinatorial materials, the method comprising providing a combinatorial library of luminescent materials, and then positioning a radioactive substance adjacent to the library, the radioactive substance configured to provide at least a portion of the combinatorial library to cause luminescence. Systems for screening such libraries are also contemplated.

The present luminescent combinatorial libraries materials may be activated by the application of an electron gun or some other electron source, such as a β-emitter. In its simplest form, a library of materials can be screened for luminescence by placing the library in a position to collect beta particles emitted from radioactive β-emitters. these materials can be activated by the application of an electron gun or some other electron source, such as a β-emitter. In its simplest form, a library of materials can be screened for luminescence by placing the library in a position to collect beta particles emitted from radioactive β-emitters.

The radioactive material may be placed adjacent to the combinatorial library in any number of a variety of configurations. The radioactive substance may be placed within or on the opposite of a substrate on which the library is deposited. Alternatively, the radioactive substance may be coated on or embedded into a transparent layer which is placed adjacent to the library, and optical screening done on luminescence which has traveled through the transparent layer.

### DETAILED DESCRIPTION OF THE INVENTION

Embodiments of the present invention are directed in general to the field of high throughput screening of combinatorial libraries; specifically, the use of an electron flux to screen combinatorial libraries comprising luminescent materials. The electron flux originates from a beta emitter (such as tritium, or ³H) positioned adjacent to the library of luminescent materials undergoing screening. The present embodiments allow libraries of materials to be quickly and easily screened for luminescence produced by the electron flux resulting from the decay of the radioactive beta emitter. The optical output from the library may be either visually observed, if the luminescence is of sufficient brightness and if a high level of quantification is not required, or an optical detector may be included in the screening if a greater degree of quantification is desired.

Many configurations are possible for positioning the radioactive beta emitter adjacent to the luminescent library. For example, a transparent sheet of polymer impregnated with tritium (³H), or a tritium-containing compound, in place of more typical hydrogen (protium, ¹H). In one such scheme, calcium carbide is reacted with ³H₂O to form tritiated acetylene. The resulting radioactive acetylene is then partially hydrogenated with tritium gas and a catalyst, such as Lindlar's catalyst (Pd/BaSO₄/quinoline), to form tritiated ethylene. The ethylene monomer may then be polymerized to synthesize fully tritiated polyethylene macromolecule. Such a polymer would contain about 33 percent by mass tritium.

The tritiated polymer may then be coated onto a substrate containing the combinatorial library to provide the activation energy necessary to cause the library to become fluorescent. Alternatively, a tritiated polymer layer may be laminated onto a transparent sheet, such as a glass or quartz plate, with the transparent sheet functioning as a barrier to the radiation, thus protecting the observer or detector from radiation damage.

In this embodiment, the transparent sheet may be placed directly over a library of materials, and luminescence from the library of materials induced by the beta radiation observed through the polymer, and quantitatively characterized using a detector array such as CCD or focal plane array (FPA). In this type of configuration, the type of detector chosen would depend on the spectral region of the luminescence produced by the library.

Alternatively, a radioactive substance may be embedded into or coated onto the substrate onto which the combinatorial library is deposited. In this embodiment, the radioactive substance may activate luminescence of the library from the substrate side, and the screening may take place from the opposite side of the library. Here, it is not necessary for luminescence from the library to travel through the radioactive layer for detection of the luminescence. Again, the radioactive substrate may comprise a glass or quartz substrate containing tritium or a tritium containing compound or polymer.

What is claimed is:

1. A method of screening a library of combinatorial materials, the method comprising:
providing a combinatorial library of luminescent materials;
positioning a radioactive substance adjacent to the library, the radioactive substance configured to provide at least a portion of the combinatorial library to cause luminescence.

2. The method of claim 1, wherein the radioactive substance is a beta-emitter.

3. The method of claim 2, wherein the beta-emitter is selected from the group consisting of tritium and a tritium-containing material.

4. The method of claim 3, wherein the beta emitter is a tritiated polymer.

5. The method of claim 4, wherein the tritiated polymer is tritiated polyethylene.

6. The method of claim 4, wherein the tritiated polymer is coated on a transparent sheet selected from the group consisting of a glass plate and a quartz plate.

7. The method of claim 1, wherein the luminescent materials of the combinatorial library comprise phosphors.

8. A method of screening a library of combinatorial materials, the method comprising:
embedding a radioactive substance into a substrate;
depositing a combinatorial library of luminescent materials onto the substrate;
wherein the radioactive substance provides energy to cause the luminescent materials to fluoresce.

9. The method of claim 8, further including the step of screening the library using luminescence from the library.

10. The method of claim 8, wherein the radioactive substance is a beta emitter.

11. The method of claim 10, wherein the beta emitter is a tritium-containing material.

12. A method of screening a library of combinatorial materials, the method comprising:
coating a radioactive substance onto a substrate;
depositing a combinatorial library of luminescent materials onto the substrate;
wherein the radioactive substance provides energy to cause the luminescent materials to fluoresce.

13. The method of claim 12, further including the step of screening the library using luminescence from the library.

14. The method of claim 12, wherein the radioactive substance is a beta emitter.

15. The method of claim 14, wherein the beta emitter is a tritium-containing material.

16. A system for screening a library of combinatorial materials, the system comprising:
a combinatorial library of luminescent materials;
a radioactive substance positioned adjacent to the library, the radioactive substance configured to provide at least a portion of the combinatorial library to cause luminescence.

17. The method of claim 16, wherein the radioactive substance is a beta emitter.

18. The method of claim 17, wherein the beta emitter is a tritium-containing material.
